(19) United States
(12) Patent Application Publication
(10) Pub. No.: US 2010/0075919 A1
(43) Pub. Date: Mar. 25, 2010

(54) COMPOSITIONS COMPRISING ALKYLDIMONIUM HYDROXYPROPYL ALKYLGLUCOSIDES

(76) Inventors: Erning Xia, Penfield, NY (US); Kimberly Millard, Rochester, NY (US)

Correspondence Address: Bausch & Lomb Incorporated, One Bausch & Lomb Place, Rochester, NY, 14604-2701, US

(21) Appl. No.: 12/235,158

(22) Filed: Sep. 22, 2008

(51) Int. Cl. A01N 43/16; A01P 1/00

(52) U.S. Cl. 514/54

(57) ABSTRACT

A pharmaceutical formulation for topical, ophthalmic or nasal administration comprising one or more alkyldimonium hydroxypropyl alkylglucosides of general formula I or general formula II and a pharmaceutical active,

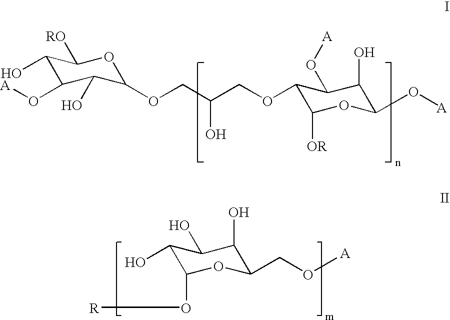

wherein R is a straight or branched C₈-C₂₄alkyl;
A is —CH₂CH(OH)CH₂N⁺(CH₃)₂R¹X⁻, wherein R¹ is a C₈-C₂₄alkyl and X⁻ is a common counteranion, n is an average value from 1 to 6 and m is an average value from 1 to 2

### FIELD OF THE INVENTION

The present invention is directed to pharmaceutical formulations, including ophthalmic formulations, comprising one or more alkyldimonium hydroxypropyl alkylglucosides. In particular, the alkyldimonium hydroxypropyl alkylglucosides can be used as a preservative in such formulations developed for topical, ophthalmic or nasal administration.

### BACKGROUND OF THE INVENTION

Dry eye, also known generically as keratoconjunctivitis sicca and dyslacrima, is a common ophthalmological disorder affecting millions of people. A patient with dry eye may experience burning, a feeling of dryness and persistent irritation. In severe cases, dry eye can impair one's vision. Certain diseases such as Sjogren's disease manifest dry eye symptoms. Also, as people age, the lacrimal glands in the eye may produce less moisture, resulting in eyes that become dry, inflamed, itchy and gritty. Although it appears that dry eye may result from a variety of underlying, unrelated pathogenic causes, all presentations of the condition share a common effect, namely the breakdown of the pre-ocular tear film, which results in dehydration of the exposed outer surface and the symptoms described.

An ophthalmic composition such as an eye drop or contact lens rewet solution typically includes a preservative agent to inhibit growth of bacteria and/or fungi if the composition becomes contaminated with such organisms. Various preservative agents are known for use in ophthalmic compositions. Such preservative agents should have a broad spectrum of preservative activity and be non-irritating to the eye. Many preservative agents, however, have a tendency to irritate eye tissue, especially if present at relatively high concentrations. Accordingly, ophthalmic compositions preserved with agents that are non-irritating to the eye are of continued interest.

U.S. Pat. No. 7,192,937 describes ophthalmic compositions containing one or more oligosaccharides in an amount effective to disinfect or preserve contact lenses, as a rewet drop for contact lenses or to preserve pharmaceutical formulations. A particular oligosaccharide described in U.S. Pat. No. 7,192,937 is stearyl dihydroxypropyldimonoim oligiosaccharide (SDO) of general formula

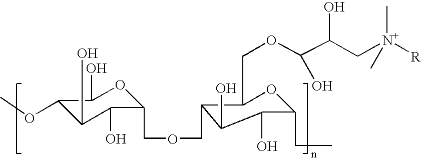

SDO is sold under the tradename Oligioquat(t M and is available from Arch Chemicals, S. Plainfield, N.J., and has a reported weight average molecular weight of 25 k to 50 k. The compositions also include an aminoalcohol buffer and a tonicity agent.

U.S. Pat. No. 6,277,365 describes ophthalmic compositions containing one or more ethoxylated glycosides with a quaternary nitrogen (alky dimonoim). The compositions can be used to disinfect or preserve contact lenses, as a rewet drop for contact lenses or to preserve pharmaceutical formulations. A particular ethoxylated glycoside described in U.S. Pat. No. 6,277,365 is of general formula

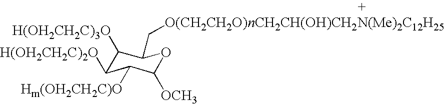

Glucoquat® 100 is available from Amerchol Corp, Edison, N.J. The compositions can also include a disinfectant such as poly(hexamethylene biguanide) and a therapeutic agent including dry eye agent such as hyaluronic acid or a drug for ophthalmic applications.

### SUMMARY OF THE INVENTION

The invention is directed to pharmaceutical formulations, including ophthalmic formulations, comprising one or more alkyldimonium hydroxypropyl alkylglucosides. In particular, the alkyldimonium hydroxypropyl alkylglucosides can be used as a preservative in formulations developed for topical, ophthalmic or nasal administration. The alkyldimonium hydroxypropyl alkylglucoside is present in the formulation in sufficient concentration to preserve the formulation from microbial contamination throughout the determined shelf-life of the formulation.

Accordingly, the invention is directed to a formulation comprising one or more alkyldimonium hydroxypropyl alkylglucosides of general formula I or general formula II and a pharmaceutical active,

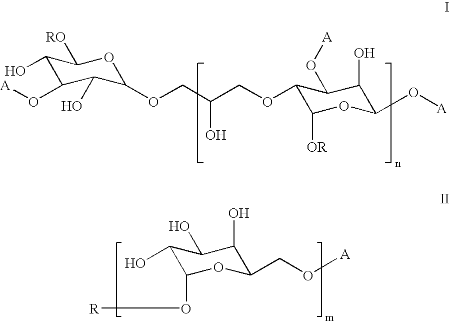

wherein R is a straight or branched C₈-C₂₄alkyl;
A is —CH₂CH(OH)CH₂N⁺(CH₃)₂R¹X⁻, wherein R¹ is a C₈-C₂₄alkyl and X⁻ is a common counteranion, n is an average value from 1 to 6 and m is an average value from 1 to 2, wherein the formulation is a pharmaceutical formulation for topical, ophthalmic or nasal administration.

### BRIEF DESCRIPTION OF THE DRAWINGS

The invention will be better understood from the following description and in consideration with the accompanying Figures. It is to be expressly understood, however, that each of the Figures is provided to further illustrate and describe the invention and is not intended to further limit the invention claimed.

FIG. 1 is a bar graph showing the intensity of fluorescence units of a sodium fluorescein permeability assay with (HCEC) for various prior art, and compositions of the invention in buffered borate solution;

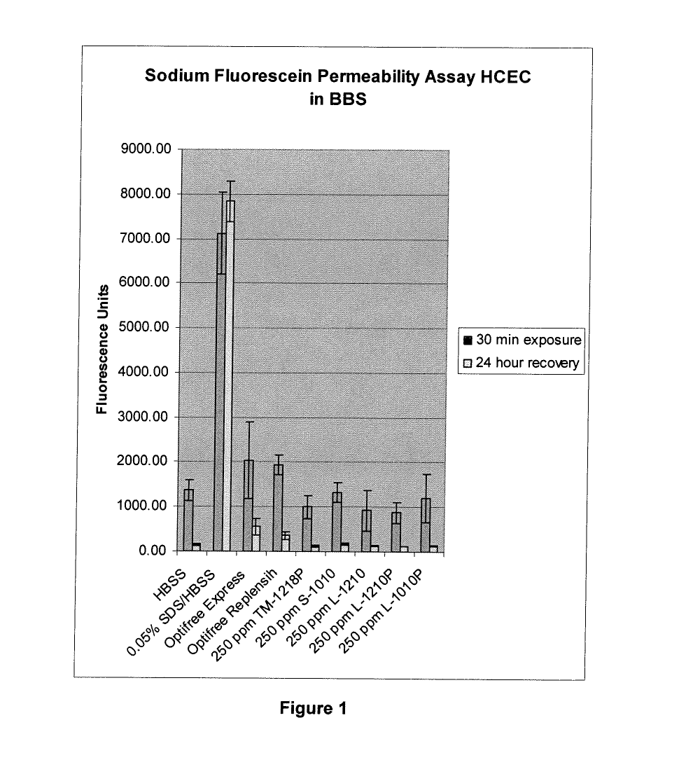

FIG. 2 is a bar graph showing the intensity of fluorescence units of a sodium fluorescein permeability assay with (MDCK) for various prior art solutions, and compositions of the invention in buffered borate solution; and

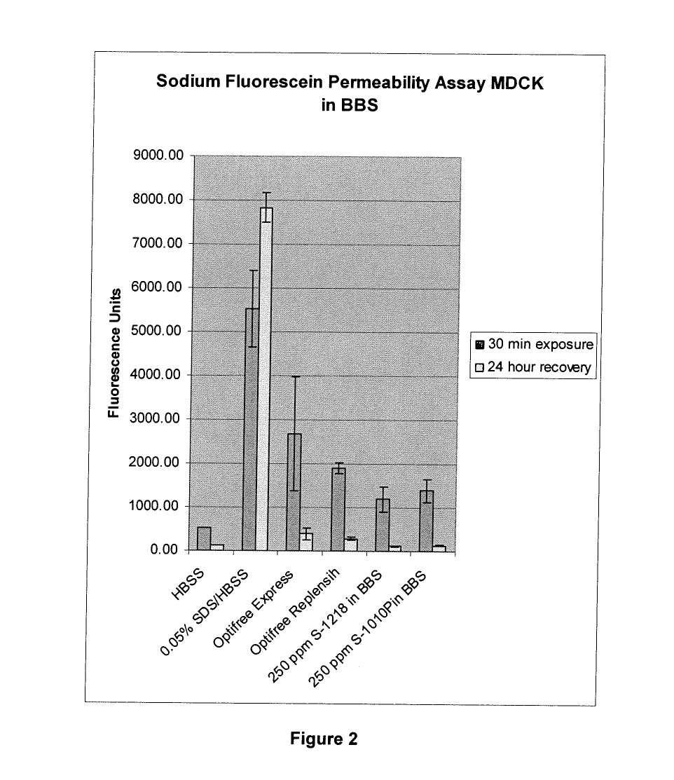

FIG. 3 is a bar graph showing the intensity of fluorescence units of a sodium fluorescein permeability assay with (HCEC) for various prior art solutions, and compositions of the invention in buffered borate solution.

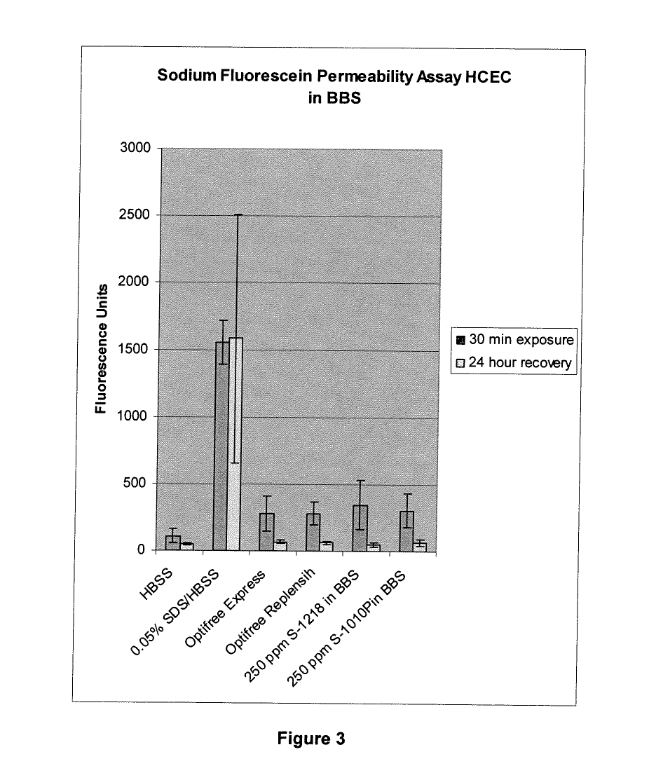

### DETAILED DESCRIPTION OF THE INVENTION

As stated, the alkyldimonium hydroxypropyl alkylglucosides can be used as a preservative in a pharmaceutical formulation such as in a nasal spray, ear and eye drop or for topical applications such as a cream or ointment. Accordingly, the alkyldimonium hydroxypropyl alkylglucosides can be used in a prescription-based pharmaceutical formulation or in a medicinal over-the-counter formulation. The alkyldimonium hydroxypropyl alkylglucoside is present in the formulation in sufficient concentration to preserve the formulation from microbial contamination throughout the determined shelf-life of the formulation.

As used herein, the term “pharmaceutical active” refers to a compound, or a mixture of compounds, that when administered to a subject (human or animal) causes a desired pharmacologic and/or physiologic effect by local and/or systemic action. Accordingly, pharmaceutical formulations comprising alkyldimonium hydroxypropyl alkylglucosides of general formula I or general formula II have the benefit of being adequately preserved without having a harsh physiological effect such as irritation or discomfort, which is common with many preservative agents.

A “preservative-effective amount” is defined as a sufficient amount of alkyldimonium hydroxypropyl alkylglucoside of general formula I or general formula II in the formulation to reduce the cell population by two log orders after 7 days of the five following microorganisms, Staphylococcus aureus, Pseudomonas aeruginosa, Eschrechia coli, Candida albicans and Aspergillus niger, or that which will prevent the growth of fungal bioburden by ±0.5 log.

Accordingly, the invention is directed to a formulation comprising one or more alkyldimonium hydroxypropyl alkylglucosides of general formula I or general formula II and a pharmaceutical active,

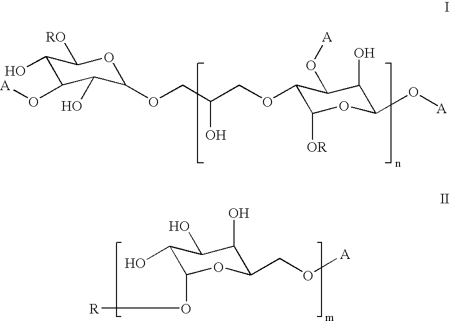

wherein R is a straight or branched C₈-C₂₄alkyl; A is —CH₂CH(OH)CH₂N⁺(CH₃)₂R¹X⁻, wherein R¹ is a C₈-C₂₄alkyl and X⁻ is a common counteranion, and a n is an average value from 1 to 6 and m is an average value from 1 to 2, wherein the formulation is a pharmaceutical formulation for topical, ophthalmic or nasal administration.

Some of the more preferred alkyldimonium hydroxypropyl alkylglucosides of general formula I is selected from the group consisting of
stearyldimonium hydroxypropyl laurylglucosides chloride (S-1218),
stearyldimonium hydroxypropyl laurylglucosides chloride (S-1210),
stearyldimonium hydroxypropyl decylglucosides chloride (S-1010),
lauryldimonium hydroxypropyl laurylglucosides chloride(L-1210),
lauryldimonium hydroxypropyl decylglucosides chloride (L-1010), and
trimonium hydroxypropyl cocoglucosides chloride (TM-8610).

Some of the more preferred alkyldimonium hydroxypropyl alkylglucoside of general formula II is selected from the group consisting of
poly(stearyldimonium hydroxypropyl laurylglucosides chloride (S-1210P),
poly(stearyldimonium hydroxypropyl decylglucosides chloride (S-1010P),
poly(lauryldimonium hydroxypropyl laurylglucosides chloride (L-1218P),
poly(lauryldimonium hydroxypropyl decylglucosides chloride (L-1010P),
poly(trimonium hydroxypropyl laurylglucosides chloride and (TM-1218P),
poly(trimonium hydroxypropyl decylglucosides chloride (TM-8610P).

In the exemplary listing of compounds above: the letter prefix corresponds to S—stearyl, L—lauryl and TM—trimethyl; the first pair of numbers corresponds to carbon atoms in the alkyl group (R) of general formula I and II with the number, 86, representing an alkyl group with 8 to 16 carbon atoms; and the second pair of numbers corresponds to the level of quat, e.g., the number 18 represents a quat value of about 1.8. The designation P represents a polymeric compound of general formula II.

Following the testing of a number of commercially available alkyldimonium hydroxypropyl alkylglucosides, Applicants observed that that both stearyl dimonium hydropropyl laurylglucoside and stearyldimonium hydropropyl decylglucoside exhibit a relatively high increase in biocidal efficacy in an aqueous buffered borate solution. In particular, against the three bacterium and two fungal strains tested a combination of stearyldimonium hydropropyl laurylglucoside and stearyldimonium hydropropyl decylglucoside appeared to provide the optimal biocidal efficacy.

In many formulations, the one or more alkyldimonium hydroxypropyl alkylglucosides of general formula I are each present in the formulation from 0.001% to 0.1% by weight. In other embodiments, the one or more alkyldimonium hydroxypropyl alkylglucosides of general formula I are each present in the formulation from 0.003% to 0.05% by weight. In still another embodiment, the one or more alkyldimonium hydroxypropyl alkylglucosides of general formula I are each present in the formulation from 0.005% to 0.015% by weight. As mentioned, the formulation can be an ophthalmic formulation prescribed by or recommended by a physician, or a health care provider, e.g., an O.D., to treat an ocular condition or an ocular disease.

Exemplary formulations for the treatment of dry eye are provided in Table 1 and Table 2. Additional information on dry eye formulations can be found in U.S. patent application Ser. No. 11/842,394, filed Aug. 21, 2007.

Another ophthalmic formulation is a sterile, buffered, hypotonic solution intended for use as an artificial tear and lubricant for providing soothing therapy to dry irritated eyes, Table 2. The solution is a non-blurring, low viscosity liquid that contains propylene glycol and glycerin as demulcents to lubricate and soothe the irritated corneal epithelium. The solution also contains alginate, a hydrocolloid, which serves to interact with the mucin layer in the tear film and helps to maintain a moist ocular surface. This helps to keep the tear film intact and provides long term relief to dry eyes.

TABLE 1

| Component | % w/w |
|---|---|
| Carbopol ® 980NF | 0.02 to 0.2 |
| glycerin | 0.01 to 0.5 |
| Sugaquat ® S-1218 | 0.001 to 0.05 |
| Sugaquat ® S-1010P | 0.001 to 0.5 |
| sorbitol | 0.5 to 5.0 |
| purified water | q.s. to 100% |

Another ophthalmic formulation is a sterile, buffered, hypotonic solution intended for use as an artificial tear and lubricant for providing soothing therapy to dry irritated eyes, Table 2. The solution is a non-blurring, low viscosity liquid that contains propylene glycol and glycerin as demulcents which lubricate and soothe the irritated corneal epithelium. The solution also contains alginate, a hydrocolloid, which serves to interact with the mucin layer in the tear film and holds moisture for a long time. This helps to keep the tear film intact and provides long term relief to the dry eyes.

TABLE 2

| Component | % w/w |
|---|---|
| Protanal LF200M | 0.05 to 0.5 |
| alginate | |
| glycerin | 0.1 to 1.0 |
| propylene glycol | 0.1 to 1.0 |
| Sugaquat ® S-1218 | 0.001 to 0.05 |
| Sugaquat ® S-1010P | 0.001 to 0.05 |
| sodium borate | 0.01 to 0.04 |
| boric acid | 0.2 to 0.8 |
| Dequest ® 2017 | 0.01 to 0.1 |
| purified water, USP | Q.S. to 100% |

1. Use of One or More Alkyldimonium Hydroxypropyl Alkylglucosides in a a Topical, Nasal or Ocular Pharmaceutical Formulation.

The pharmaceutical active can be any compound that is used to treat any one disease or any one medical condition. Accordingly, the pharmaceutical agent can be selected from any one class of compounds, for example, anti-inflammatory agents, anti-infective agents (including antibacterial, antifungal, antiviral, antiprotozoal agents), anti-allergic agents, antiproliferative agents, anti-angiogenic agents, anti-oxidants, antihypertensive agents, neuroprotective agents, cell receptor agonists, cell receptor antagonists, immunomodulating agents, immunosuppressive agents, IOP lowering agents, beta adrenoceptor antagonists, alpha-2 adrenoceptor agonists, carbonic anhydrase inhibitors, cholinergic agonists, prostaglandins and prostaglandin receptor agonists, angiotensin converting enzyme (“ACE”) inhibitors, AMPA receptor antagonists, NMDA antagonists, angiotensin receptor antagonists, somatostatin agonists, mast cell degranulation inhibitors, alpha-adrenergic receptor blockers, alpha-2 adrenoceptor antagonists, thromboxane A2 mimetics, protein kinase inhibitors, prostaglandin F derivatives, prostaglandin-2 alpha antagonists, cyclooxygenase-2 inhibitors and muscarinic agents.

Of particular interest are pharmaceutical active agents that are known to treat an ocular disease or disorder including, but are not limited to, a posterior-segment disease or disorder. In certain embodiments, such disease or disorder is selected from the group consisting of diabetic retinopathy, diabetic macular edema, cystoid macular edema, age macular degeneration (including the wet and dry form), optic neuritis, retinitis, chorioretinitis, intermediate and posterior uveitis and choroidal neovascuralization.

Glaucoma is a group of diseases that are characterized by the death of retinal ganglion cells (“RGCs”), specific visual field loss, and optic nerve atrophy. Glaucoma is the third leading cause of blindness worldwide. An intraocular pressure (“IOP”) that is high compared to the population mean is a risk factor for the development of glaucoma. However, many individuals with high IOP do not have glaucomatous loss of vision. Conversely, there are glaucoma patients with normal IOP. Therefore, continued efforts have been devoted to elucidate the pathogenic mechanisms of glaucomatous optic nerve degeneration.

It has been postulated that optic nerve fibers are compressed by high IOP, leading to an effective physiological axotomy and problems with axonal transport. High IOP also results in compression of blood vessels supplying the optic nerve heads (“ONHs”), leading to the progressive death of RGCs. See; e.g., M. Rudzinski and H. U. Saragovi, Curr. Med. Chem.-Central Nervous System Agents, Vol. 5, 43 (2005).

In one embodiment, the anti-glaucoma pharmaceutical agent is of general formula II

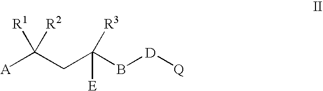

wherein A and Q are independently selected from the group consisting of aryl and heteroaryl groups substituted with at least a halogen atom, cyano group, hydroxy group, or C₁-C₁₀ alkoxy group; R¹, R², and R³ are independently selected from the group consisting of unsubstituted and substituted C₁-C₅ alkyl groups; B is a C₁-C₅ alkylene group; D is the —NH— or —NR′— group, wherein R′ is a C₁-C₅ alkyl group; and E is the hydroxy group.

Exemplary, pharmaceutical agents of general formula II include A as a dihydrobenzofuranyl group substituted with a fluorine atom; Q as a quinolinyl or isoquinolinyl group substituted with a methyl group; R¹ and R² are independently selected from the group consisting of unsubstituted and substituted C₁-C₅ alkyl groups; B is a C₁-C₃ alkylene group; D is the —NH— group; E is a hydroxy group; and R³ is a trifluoromethyl group.

Exemplary compounds include a glucocorticoid receptor agonist having Formulae III or IV, as disclosed in US Patent Application Publication 2006/0116396.

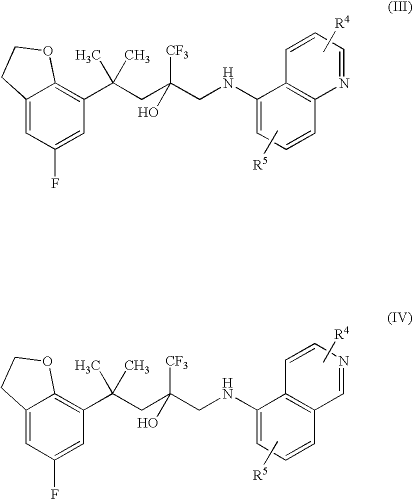

wherein R⁴ and R⁵ are independently selected from the group consisting of hydrogen, halogen, cyano, hydroxy, C₁-C₁₀ (alternatively, C₁-C₅ or C₁-C₃) alkoxy groups, unsubstituted C₁-C₁₀ (alternatively, C₁-C₅ or C₁-C₃) linear or branched alkyl groups, substituted C₁-C₁₀ (alternatively, C₁-C₅ or C₁-C₃) linear or branched alkyl groups, unsubstituted C₃-C₁₀ (alternatively, C₃-C₆ or C₃-C₅) cyclic alkyl groups, and substituted C₃-C₁₀ (alternatively, C₃-C₆ or C₃-C₅) cyclic alkyl groups.

Compositions of the invention also include ocular formulations prescribed by or recommended by a physician, or a health care provider, to treat an ocular allergic conditions. Allergy is characterized by a local or systemic inflammatory response to allergens. Allergic conjunctivitis is a disorder that is characterized by the clinical signs and symptoms of eye itching, redness, tearing, and swelling. An estimated 20% of the population in the United States suffer from inflammation of the eye. The signs and symptoms of allergic conjunctivitis can significantly impact the quality of life of patients, from social interactions, productivity at work and school, to the ability to perform visual tasks such as working on a computer or reading.

Currently, available pharmaceutical treatments for inflammation of the eye or symptoms of inflammation of the eye include (1) antihistamines, (2) drugs that block the release of histamine and other substances from the mast cell (e.g., mast cell stabilizers), (3) drugs with multiple modes of action (e.g. antihistamine/mast cell stabilizing agents), and (4) drugs that can actively constrict blood vessels thus reducing redness and swelling (e.g., vasoconstrictors). Additionally, artificial tears have been used to wash the eye of allergens.

The desirability of a particular treatment for inflammation of the eye can be measured against the following factors (1) efficacy at onset of action, (2) duration of action, (3) efficacy at controlling signs and symptoms of allergic conjunctivitis, and (4) comfort of the drop when instilled in the eye.

In still another aspect, the composition comprising: (a) ketotifen or a salt thereof in a concentration of from about 0.001% to about 0.2% (weight/volume or “w/v”); (b) naphazoline or a salt thereof in a concentration of from about 0.001% to about 0.2% (w/v); and (c) water.

Ketotifen or any ophthalmically acceptable ketotifen salt may be used in the method herein described, although ketotifen fumarate is preferred. Ketotifen fumarate is represented by the following formula:

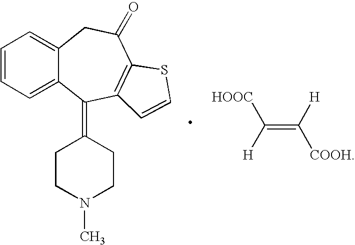

Ketotifen or a ketotifen salt may be present in a composition produced by a method in a concentration from about 0.001% to about 0.2% (or alternatively, from about 0.001% to about 0.1%). In one embodiment, ketotifen or a ketotifen salt is present in a concentration from about 0.01% to about 0.05%; preferably, from about 0.01% to about 0.04%; more preferably, from about 0.02% to about 0.03%. In some embodiments, the method provides stability to compositions comprising a ketotifen or ketotifen salt in a concentration such that the concentration of ketotifen in the composition is from about 0.01% to about 0.05%; preferably, from about 0.0225% to about 0.0275%; more preferably, about 0.025%. Concentrations of ketotifen salts yielding such concentrations of ketotifen may be readily calculated; for example, using ketotifen fumarate in a concentration of about 0.0345% in the composition provides a concentration of ketotifen in the composition of 0.025%.

The ophthalmic compositions prepared by the methods herein disclosed may include an anti-redness agent, which may relieve redness in the eye. The preferred anti-redness agent is naphazoline or an ophthalmically acceptable salt thereof such as, for example, naphazoline hydrochloride. Other anti-redness agents that may be used include, but are not limited to, tetrahydrozoline, ephedrine, phenylephrine, oxymetazoline, xylometazoline, pseudoephedrine, tramazoline, other vasoconstrictors, combinations thereof, as well as ophthalmically acceptable salts thereof (e.g., tetrahydrozoline hydrochloride). Naphazoline hydrochloride is represented by the following formula:

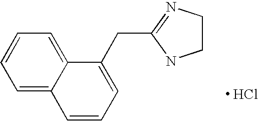

Naphazoline or a naphazoline salt may be present in a composition produced a method of the present invention in a concentration from about 0.001% to about 0.2% (or alternatively, from about 0.001% to about 0.1%). In one embodiment, naphazoline or a naphazoline salt is present in a composition at a concentration from about 0.01% to about 0.1%; preferably, from about 0.01% to about 0.07%; more preferably, from about 0.02% to about 0.06%. In some embodiments, the method provides stability to compositions comprising naphazoline or a naphazoline salt in a concentration such that the concentration of naphazoline in the composition is about 0.02% to about 0.05%. Concentrations of a naphazoline salt yielding such concentrations of naphazoline base may be readily calculated; for example, using naphazoline hydrochloride in a concentration of about 0.025% in the composition provides a concentration of naphazoline base in the composition of 0.021%.

Additional information on formulations containing ketotifen, naphazoline or a corresponding pharmaceutically salt of each thereof can be found in U.S. patent application Ser. No. 10/972,571,filed Oct. 25, 2005.

In one aspect, the method herein described provides stability to pharmaceutical compositions, such as ophthalmic solutions, adjusted with tonicity agents to approximate the osmotic pressure of normal lachrymal fluids, which, as stated in U.S. Pat. No. 6,274,626, is equivalent to a 2.5% solution of glycerol. Osmotic pressure, measured as osmolality, is generally about 225 to 400 mOsm/kg for conventional ophthalmic solutions.

However, in some embodiments, the pharmaceutical composition may be formulated to osmolality in the range from about 400 to about 875 mOsm/kg, for some desired purposes. In particular, such osmolality may be employed if the composition is formulated to be well tolerated by a user. For example, co-assigned U.S. Patent Application No. 2006/0148899, incorporated herein by reference in its entirety, provides for ophthalmic solutions having osmolality from 400 to 875 mOsm/kg, which have been found still to provide comfort to a user.

Compositions of the invention also include pharmaceutical formulations prescribed by or recommended by a physician, or a health care provider, to treat a dermatological condition or a dermatological disease. For example, it is known that compounds of the FK506 class can be formulated into stable emulsions. Emulsions, since they contain an aqueous phase, are much less occlusive than oil-based compositions and hence are better tolerated in many situations. Accordingly, in one embodiment a topical formulation, in the form of an emulsion, comprises a compound of the FK506 class, a physiologically acceptable alkanediol, ether diol or diether alcohol containing up to 8 carbon atoms as solvent for the compound of the FK506 class and one or more alkyldimonium hydroxypropyl alkylglucosides as a preservative agent. A compound of the “FK506 class” is a compound which has the basic structure as FK506 and which has at least one of the biological properties of FK506 (e.g., immunosuppressant properties). The compound may be in free base form or pharmaceutically acceptable, acid addition, salt form. A preferred compound of the FK 506 class is disclosed in EP 427 680, e.g. Example 66a (also called 33-epi-chloro-33 -desoxyascomycin).

### EXAMPLES 1 TO 8

Data obtained from a preservative efficacy response study of S-1218 with or without the stated concentrations of PHMB in borate-buffered solution containing 0.85 wt. % sodium borate, 0.06 wt. % boric acid and 0.26 wt. % sodium chloride is provided in Tables 3A and 3B. The study also included a response against S. Aureus, P. Aeruginosa, E. Coli, and C. Albicans. This data is excluded because even at 0.1 ppm PHMB in the absence of S-1218 the solutions passed with log reduction values of >4.5, that is, variability was only observed with A. Niger. Accordingly, the presence of S-1218 in the solutions with or without PHMB shows significant biocidal control of A. Niger.

### EXAMPLES 9 TO 12

Data obtained from a preservative efficacy response study of select alkyldimonium hydroxypropyl alkylglucosides of general formula I or general formula II in borate-buffered solution containing 0.85 wt. % sodium borate, 0.06 wt. % boric acid and 0.26 wt. % sodium chloride is provided in Table 4. Example 9 includes 0.2 wt. % S-1218; Example 10 includes 0.2 wt. % S-1010P; Example 11 includes 0.2 wt. % L-1210P; and Example 12 includes 0.2 wt. % S-1010. The study also included a response against S. Aureus, P. Aeruginosa, E. Coli, and C. Albicans. This data is excluded because all solutions passed with log reduction values of >4.7, that is, variability was only observed with A. Niger.

TABLE 3A
Preservative Efficacy Against A. Niger

| | | Ex. No. | | | | | |
|---|---|---|---|---|---|---|---|
| | | Comp. | Comp. | Comp. | | | |
| | | 1 | 2 | 3 | 1 | 2 | 3 |
| PHMB (ppm) | | — | 0.5 | 0.3 | — | 0.5 | 0.3 |
| S-1218 (ppm) | | — | — | — | 50 | 50 | 50 |
| microbe | days | | | | | | |
| A. Niger | 14 | 1.1 | 1.1 | 1.1 | 4.0 | >4.5 | >4.5 |
| | 21 | 1.1 | 1.0 | 0.9 | >4.5 | >4.5 | >4.5 |

TABLE 3B
Preservative Efficacy Against A. Niger

| | | Ex. No. | | | | | |
|---|---|---|---|---|---|---|---|
| | | Comp. 4 | 4 | 5 | 6 | 7 | 8 |
| PHMB (ppm) | | 0.1 | — | — | 0.1 | 0.1 | 0.1 |
| S-1218 (ppm) | | — | 25 | 12.5 | 50 | 25 | 12.5 |
| microbe | days | | | | | | |
| A. Niger | 14 | 1.1 | 1.4 | 1.3 | 4.4 | 1.4 | 1.3 |
| | 21 | 1.2 | 1.2 | 1.2 | >4.6 | 1.8 | 1.8 |

TABLE 4
Preservative Efficacy Against A. Niger

Ex. No.

| microbe | days | 9 | 10 | 11 | 12 |
|---|---|---|---|---|---|
| A. Niger | 14 | 4.6 | 3.8 | 3.1 | 3.8 |
| | 21 | 4.6 | 4.0 | 3.3 | 3.9 |

We claim:

1. A formulation comprising one or more alkyldimonium hydroxypropyl alkylglucosides of general formula I or general formula II and a pharmaceutical active, 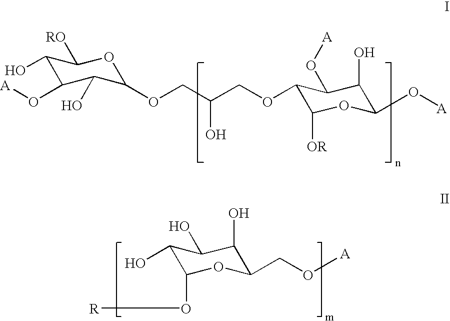
wherein R is a straight or branched C₈-C₂₄alkyl;
A is —CH₂CH(OH)CH₂N⁺(CH₃)₂R¹X⁻, wherein R¹ is a C₈-C₂₄alkyl and X⁻ is a common counteranion, and a n is an average value from 1 to 6 and m is an average value from 1 to 2, wherein the formulation is a pharmaceutical formulation for topical, ophthalmic or nasal administration.

2. The formulation of claim 1 wherein the alkyldimonium hydroxypropyl alkylglucoside of general formula I is selected from the group consisting of
stearyldimonium hydroxypropyl laurylglucosides chloride,
stearyldimonium hydroxypropyl laurylglucosides chloride,
stearyldimonium hydroxypropyl decylglucosides chloride,
lauryldimonium hydroxypropyl laurylglucosides chloride,
lauryldimonium hydroxypropyl decylglucosides chloride and
trimonium hydroxypropyl cocoglucosides chloride.

3. The formulation of claim 1 wherein the alkyldimonium hydroxypropyl alkylglucoside of general formula II is selected from the group consisting of
poly(stearyldimonium hydroxypropyl laurylglucosides chloride,
poly(stearyldimonium hydroxypropyl decylglucosides chloride,
poly(lauryldimonium hydroxypropyl laurylglucosides chloride,
poly(lauryldimonium hydroxypropyl decylglucosides chloride,
poly(trimonium hydroxypropyl laurylglucosides chloride and
poly(trimonium hydroxypropyl decylglucosides chloride.

4. The formulation of claim 1 wherein the alkyldimonium hydroxypropyl alkylglucoside of general formula I or general formula II is present in the formulation from 0.001% to 0.1% by weight.

5. The formulation of claim 4 wherein the alkyldimonium hydroxypropyl alkylglucoside of general formula I or general formula II is present in the formulation from 0.003% to 0.05% by weight.

6. The formulation of claim 1 wherein the one or more alkyldimonium hydroxypropyl alkylglucoside includes stearyldimonium hydropropyl laurylglucoside.

7. The formulation of claim 1 wherein the one or more alkyldimonium hydroxypropyl alkylglucoside includes stearyldimonium hydropropyl decylglucoside.

8. The formulation of claim 1 further comprising poly(hexamethylene biguanide) at a concentration form 0.05 ppm to 0.5 ppm.

9. The formulation of claim 1 wherein the pharmaceutical active is prescribed by or recommended by a physician, or a health care provider, to treat an ocular condition or an ocular disease.

10. The formulation of claim 1 wherein the ocular condition is dry eye.

11. The formulation of claim 1 wherein the pharmaceutical active is prescribed by or recommended by a physician, or a health care provider, to treat a dermatological condition or a dermatological disease.

12. The formulation of claim 1 wherein the pharmaceutical active is prescribed by or recommended by a physician, or a health care provider, to treat seasonal allergies.

13. A formulation comprising one or more alkyldimonium hydroxypropyl alkylglucosides selected from the group consisting of stearyldimonium hydropropyl laurylglucoside, stearyldimonium hydropropyl decylglucoside and poly(lauryldimonium hydroxypropyl laurylglucosides chloride, wherein the formulation is a pharmaceutical formulation for ophthalmic or nasal administration.

14. The formulation of claim 13 wherein the total concentration of the one or more alkyldimonium hydroxypropyl alkylglucosides in the formulation is from 0.003% to 0.05% by weight.

15. The formulation of claim 13 further comprising a pharmaceutical active that is effective for treating a patient diagnosed with an ocular disease selected from glaucoma, diabetic retinopathy, diabetic macular edema, cystoid macular edema, age macular degeneration, optic neuritis, retinitis, chorioretinitis, intermediate and posterior uveitis and choroidal neovascuralization

16. The formulation of claim 13 further comprising a pharmaceutical active that is effective for treating a patient with an ocular allergic condition or inflammation of the eye.
